(19) United States
(12) Patent Application Publication
(10) Pub. No.: US 2013/0341149 A1
(43) Pub. Date: Dec. 26, 2013

(54) CLUTCH FOR A VACUUM SWEEPER

(71) Applicant: NSS Enterprises, Inc., Toledo, OH (US)

(72) Inventors: Mark N. Rupp, Delaware, OH (US); Paul Goetz, Maple Grove, MN (US); Jeffery Scott Kunkler, Shenzhen (CN); Aurelio M. Arellano, JR., Cagayan Valley (PH); Benjo Lapuebla Manuel, Nueva Vizcaya (PH)

(21) Appl. No.: 13/925,058

(22) Filed: Jun. 24, 2013

Related U.S. Application Data
(60) Provisional application No. 61/663,914, filed on Jun. 25, 2012.

(51) Int. Cl. F16D 7/00

(52) U.S. Cl. CPC F16D 7/00
USPC 192/56.62

(57) ABSTRACT

A clutch for a vacuum sweeper includes a driver member and a clutch disk engaged with the driver member. The clutch disk has a drive portion. An axially biasing member is disposed between the driver member and the clutch disk. A shaft extends past the axial biasing member and through the driver member and clutch disk. A plurality of balls are positioned about the shaft. Each ball is disposed in a radially extending groove in the drive portion. The clutch also includes a driven member having a driven disk. The driven disk is positioned adjacent the plurality of balls and engaged with the drive portion.

### CROSS-REFERENCE TO RELATED APPLICATION

This application is claiming the benefit, under 35 U.S.C. 119(e), of the provisional application which was granted Ser. No. 61/663,914 filed on Jun. 25, 2012, the entire disclosure of which is hereby incorporated by reference.

### BACKGROUND OF THE INVENTION

This invention relates generally to vacuum sweepers, and more specifically to a clutch for a vacuum sweeper.

Upright vacuum sweepers collect dust and debris materials via vacuum suction and with the help of a rotating brush. Typically, the rotating brush is connected to and driven by a motor. Under certain conditions, an object may be ingested by the vacuum sweeper which prevents the brush from rotating. When this occurs, the brush, the brush drive components such as a belt, and/or the motor can be damaged if the object is not removed quickly.

Thus, it would be desirable to prevent damage from occurring to the brush, brush drive components and motor if the brush becomes jammed. Also, it would be desirable to provide the operator with sufficient time to remove an object should it become jammed before damage to brush, brush drive components, and/or motor can occur.

### BRIEF SUMMARY OF THE INVENTION

Embodiments of a clutch for a vacuum sweeper are provided.

In an embodiment, the clutch comprises a driver member. A clutch disk is engaged with the driver member. The clutch disk comprises a drive portion. An axially biasing member is disposed between the driver member and the clutch disk. A shaft extends past the axial biasing member and through the driver member and the clutch disk. A plurality of balls are positioned about the shaft. Each ball is disposed in a radially extending groove in the drive portion. The clutch also comprises a driven member. The driven member comprises a driven disk which is positioned adjacent the plurality of balls and engaged with the drive portion.

In another embodiment, the clutch comprises a driver member. The driver member comprises an inner surface and a generally cylindrical outer surface having a plurality of grooves formed therein. A retaining member is attached to an end of the driver member. The retaining member comprises an inner surface having a lip disposed thereon. A clutch disk is disposed between the lip of the retaining member and the inner surface of the driver member and engaged to the driver member. The clutch disk comprises a drive surface. An axially biasing member is disposed between the driver member and the clutch disk. A shaft extends past the axial biasing member and through the driver member and the clutch disk. A plurality of balls are positioned about the shaft. Each ball is disposed in a radially extending groove in the drive portion. The clutch also comprises a driven member. The driven member comprises a driven disk which is positioned adjacent the plurality of balls and engages the drive portion.

In another embodiment, the clutch comprises a driver member. A clutch disk is engaged with the driver member. The clutch disk comprises a drive portion having a plurality of raised drive members and radially extending grooves. A ball is disposed in each groove and positioned in an outer portion of the groove. An axially biasing member is disposed between the driver member and the clutch disk. The clutch also comprises a driven member separated from the axial biasing member by the clutch disk. The driven member comprises a driven disk separated from the drive portion by a space.

### BRIEF DESCRIPTION OF THE SEVERAL VIEWS OF THE DRAWINGS

The above, as well as other advantages of the present invention will become readily apparent to those skilled in the art from the following detailed description when considered in the light of the accompanying drawings in which:

FIG. 1 shows a perspective view of a portion of a vacuum sweeper according to embodiments of the invention;

FIG. 2 shows a perspective view of a clutch for the vacuum sweeper of FIG. 1 in accordance with an embodiment of the invention;

FIG. 3 shows a side view of the clutch of FIG. 2;

FIG. 4 shows a perspective view of the clutch of FIG. 2 in a partially assembled state.

FIG. 5 shows an exploded perspective view of the clutch of FIG. 2;

FIG. 6 shows a cross-sectional view of the clutch of FIG. 2 taken along line 6-6 of FIG. 3;

FIG. 7 shows a cross-sectional view of an embodiment of the clutch of FIG. 2 taken along 7-7; and

FIG. 8 shows a cross-sectional view of another embodiment of the clutch of FIG. 2 taken along 8-8.

### DETAILED DESCRIPTION OF THE INVENTION

It is to be understood that the invention may assume various alternative orientations and step sequences, except where expressly specified to the contrary. It is also to be understood that the specific assemblies and methods illustrated in the attached drawings, and described in the following specification are simply exemplary embodiments of the inventive concepts. Hence, specific dimensions, directions, and other physical characteristics relating to the embodiments disclosed are not to be considered as limiting, unless expressly stated otherwise. Also, although they may not be, like elements in various embodiments may be commonly referred to with like reference numerals within this section of the application.

A clutch 10 for a vacuum sweeper 12 is provided and, in certain embodiments, will be described in connection with an upright vacuum sweeper. However, the clutch 10 is not limited to use with upright vacuum sweepers, by the type of upright vacuum sweeper it is used with, or by the type of separating apparatus utilized in the vacuum sweeper. Also, the clutch 10 is preferably driven by a motor (not depicted) which is housed within a main body 14. The motor can be any suitable motor for use in a vacuum sweeper 12. The main body 14 also houses a dust separating apparatus (not depicted) which may be, for example, a filter bag or cyclonic separator.

As shown, the vacuum sweeper 12 includes the main body 14 mounted on a pair of wheels 16. A brush roller 18 is rotatably mounted in a manner such that the brush roller 18 would extend across a dirty air inlet (not depicted) of the vacuum sweeper 12. The brush roller 18 can be of any known design and is arranged to agitate dust and debris materials from a floor. The brush roller 18 preferably has bristles extending between both edges of the roller 18 to facilitate edge-to-edge cleaning. However, it should be appreciated that the clutch 10 is not limited by the type or configuration of the brush roller 18.

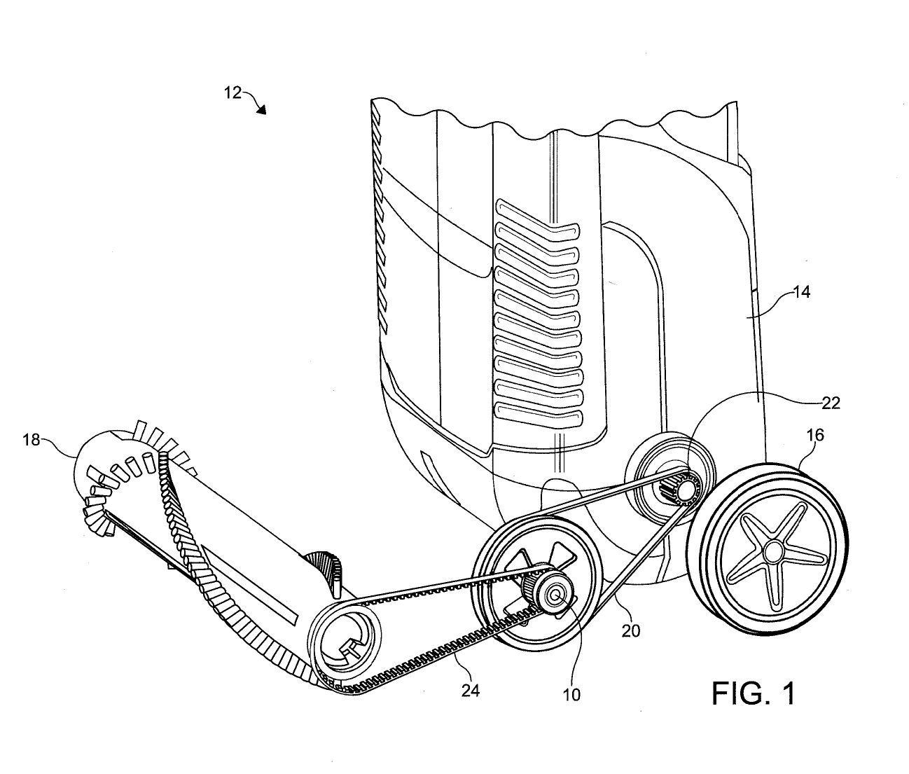

The clutch 10 is positioned between the motor housed within the main body 14 and the brush roller 18. A first drive belt 20 is attached to a pulley 22 connected to the motor to transfer torque from the motor to the clutch 10. In other embodiments (not depicted) of the vacuum sweeper 12, the first drive belt 20 could be carried directly on the motor shaft. On an opposite side of the clutch 10, a second drive belt 24 is provided to transfer torque from the clutch 10 to the brush roller 18. As shown in FIG. 1, in certain embodiments, the drive belts 20, 24 can be of the toothed variety. However, it should also be appreciated that in other embodiments the drive belts 20, 24 could be of the grooved, ribbed, V, synchronized or flat variety.

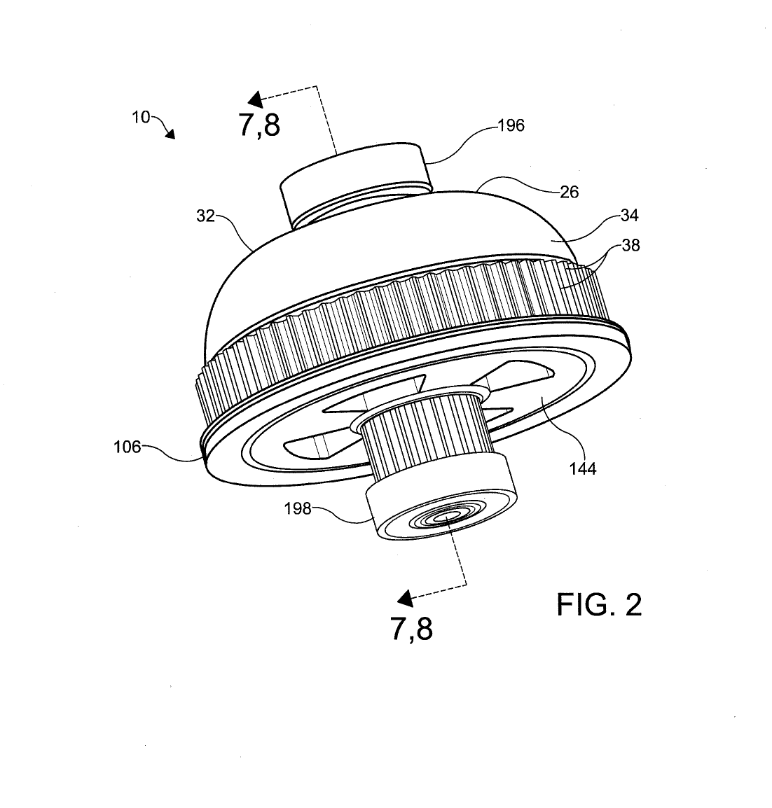

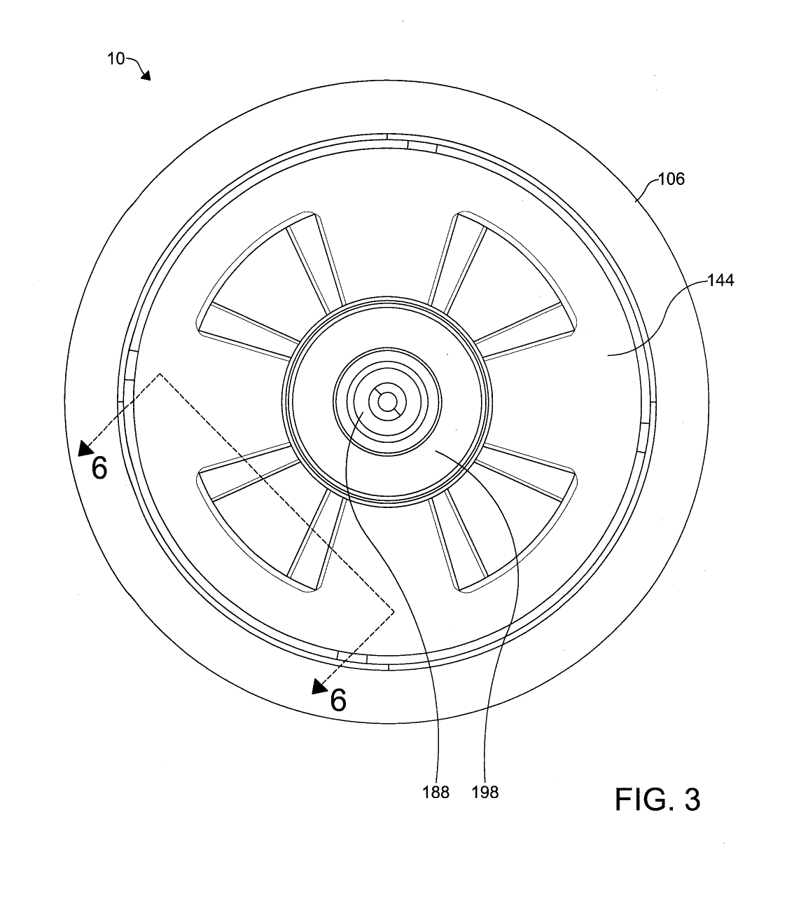

The clutch 10 will now be described with reference to FIGS. 2-8.

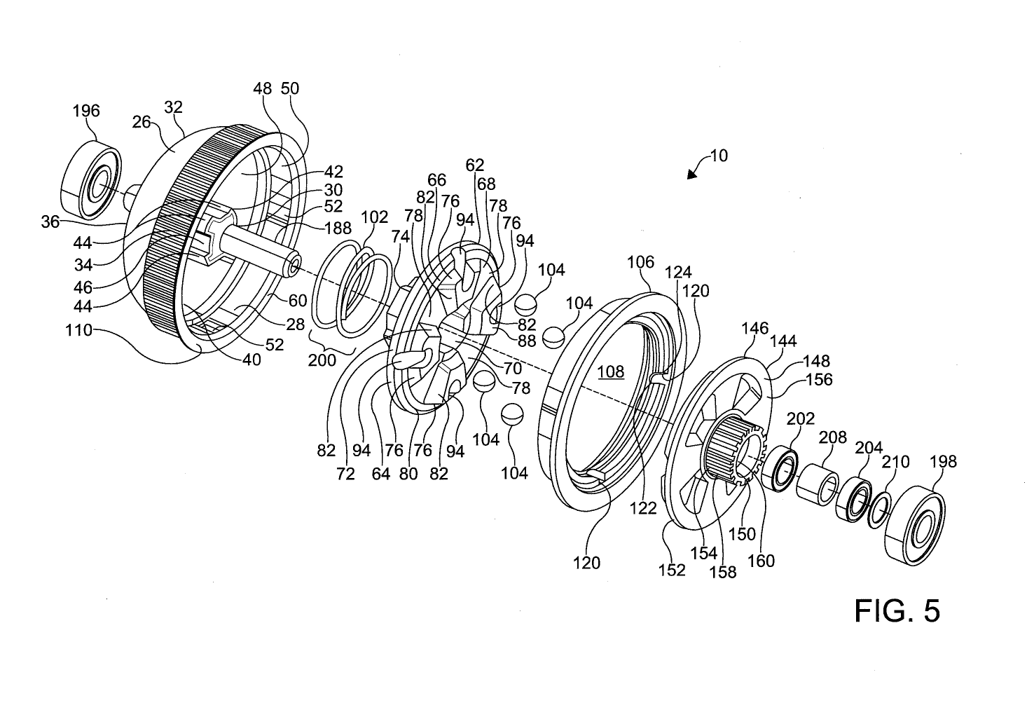

As shown best in FIGS. 2-5, the clutch comprises a driver member 26. In an embodiment, the driver member 26 is formed in a unitary manner. Preferably, the driver member 26 is formed as a rigid body. In certain embodiments, the driver member 26 may be formed of glass filled nylon. However, other plastic materials may be suitable for use in forming the driver member 26. Preferably, the driver member 26 comprises an inboard surface 28, inner surface 30 and outer surface 32 as shown in FIG. 5.

Preferably, the outer surface 32 comprises a first portion 34 and a second portion 36. The first portion 34 may have a generally cylindrical shape. The first portion 34 may be driven by and configured to engage the first drive belt 20 when, for example, the first drive belt 20 is toothed. In this embodiment, the first portion 34 comprises a plurality of grooves 38 formed therein for engaging the teeth on the belt 20. In other embodiments (not depicted), the first portion 34 may be smooth. The second portion 36 may have a generally hemispherical shape.

Preferably, the inboard surface 28 comprises a bowl-shaped portion 40 and a raised splined portion 42. The raised splined portion 42 is attached to and, preferably, is concentric with the bowl-shaped portion 40. Also, the raised splined portion 42 extends axially from the bowl-shaped portion 40.

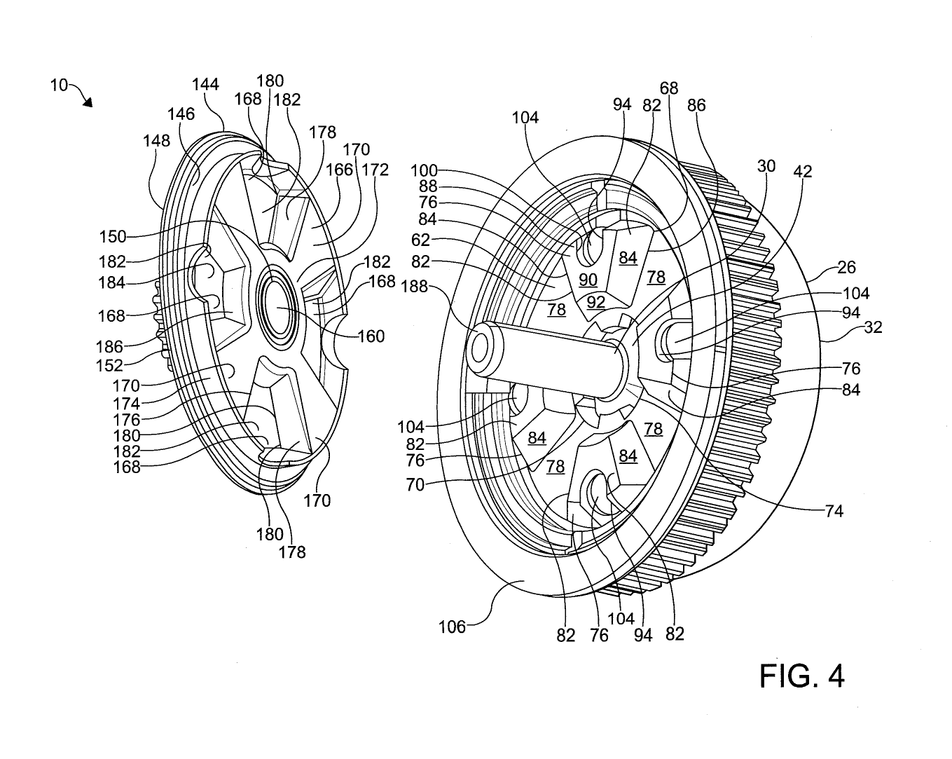

Preferably, the raised splined portion 42 comprises a plurality of spline members 44 attached to a generally cylindrically-shaped body 46 as is illustrated in FIG. 4. The spline members 44 are attached to and extend radially from and axially along the cylindrically-shaped body 46. In an embodiment, four spline members 44 are attached to and extend along the cylindrically-shaped body 46. The spline members 44 are in a spaced apart relationship with each other.

Preferably, the bowl-shaped portion 40 comprises a lower portion 48 and an upper portion 50, which are attached to each other. A plurality of attaching portions 52 are provided circumferentially on the inboard surface 28. Preferably, the attaching portions 52 are provided on the upper portion 50 of the bowl-shaped portion 40. More preferably, four attaching portions 52 are provided and equally spaced apart from each other.

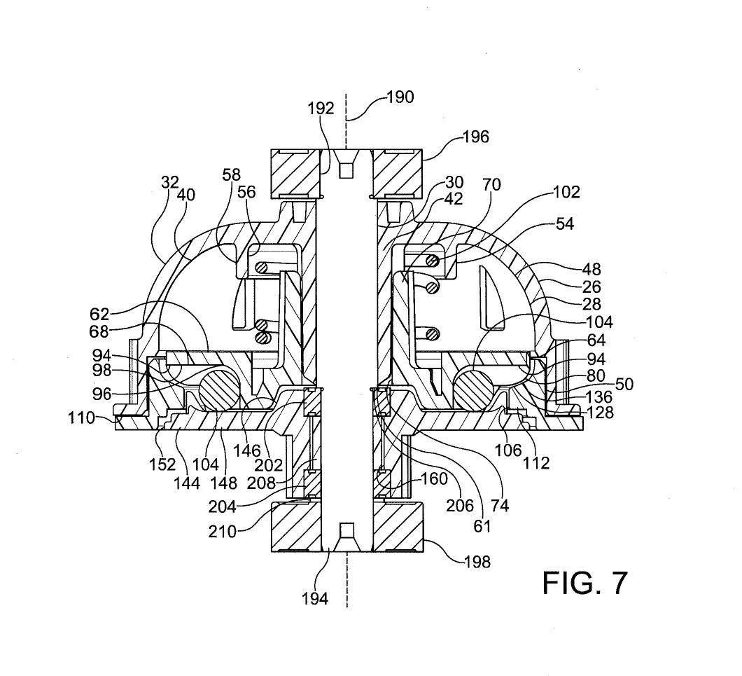

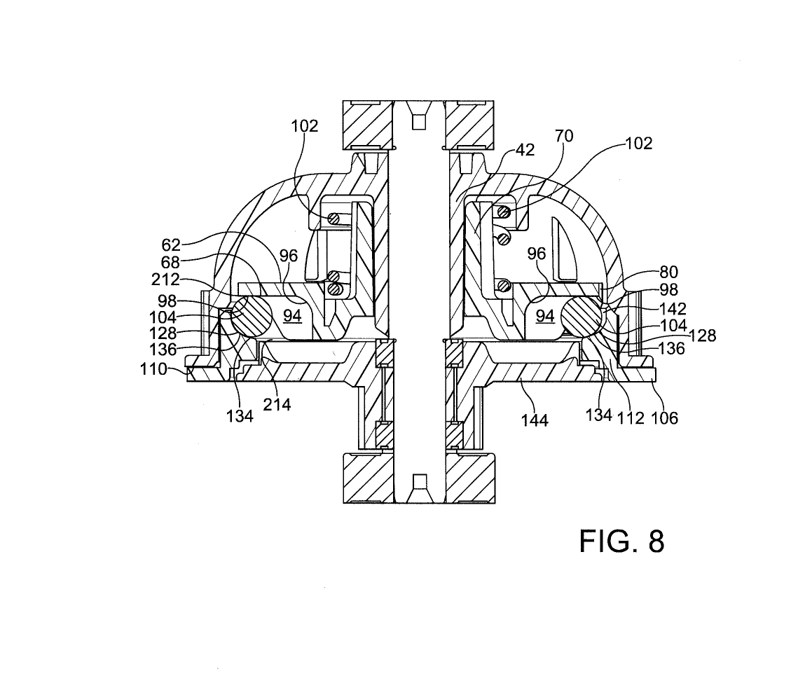

As best shown in FIGS. 7-8, the inboard surface 28 also preferably comprises an inner wall 54. The inner wall 54 is attached to the lower portion 48 of the bowl-shaped portion 40. The inner wall 54 is concentric with the raised splined portion 42 and the bowl-shaped portion 40. In an embodiment, the inner wall 54 is provided adjacent and surrounds a portion of the raised splined portion 42. The inner wall 54 has an inner diameter 56 and an outer diameter 58. The lengths of the inner diameter 56 and the outer diameter 58 may be substantially constant.

Referring now to FIGS. 4-5 and 7, the inner surface 30 of the driver member 26 defines an aperture 61. The aperture 61 extends axially from the outer surface 32 through the raised splined portion 42. Preferably, the aperture 61 has a substantially constant diameter.

Referring back to FIG. 5, the driver member 26 may also comprise a flange 60. The flange 60 is attached to the inboard surface 28 and the outer surface 32. In an embodiment, the flange 60 is attached to the bowl-shaped portion 40 of the inboard surface 28 and the first portion 34 of the outer surface 32.

The clutch 10 also comprises a clutch disk 62. In an embodiment, the clutch disk 62 is formed in a unitary manner. Preferably, the clutch disk 62 is formed as a rigid body. In certain embodiments, the clutch disk 62 may be formed of glass filled nylon. However, other plastic materials may be suitable for use in forming the clutch disk 62. Preferably, the clutch disk 62 comprises an outer surface 64, an inboard portion 66, a drive portion 68 and a splined portion 70.

The outer surface 64 is separated from the splined portion 70 by the drive portion 68 and the inboard portion 66. In an embodiment, the outer surface 64 comprises an outer diameter 72. In this embodiment, the outer diameter 72 may be substantially constant.

The splined portion 70 defines an aperture 74. The aperture 74 extends axially through the clutch disk 62. In an embodiment, the aperture 74, outer surface 64, inboard portion 66, and drive portion 68 are concentric with each other. To transmit torque, the clutch disk 62 is engaged with the driver member 26 via a connection between the raised splined portion 42 of the driver member 26 and the splined portion 70 of the clutch disk 62. To assemble the clutch 10, the raised splined portion 42 is received by and positioned within the aperture 74 defined by the splined portion 70.

Preferably, the splined portion 70 and the drive portion 68 are concentric with each other and with the driver member 26. The drive portion 68 comprises a plurality of drive members 76. As illustrated in FIGS. 4 and 5, four drive members 76 may be provided. However, the clutch 10 is not limited to embodiments with four drive members. Thus, less than four drive members may be provided or more than four drive members may be provided.

Preferably, the drive portion 68 also comprises a plurality of planar portions 78. Each planar portion 78 is attached to at least one drive member 76 and, preferably, a pair of drive members 76. As illustrated, four planar portions 78 may be provided and are separated from each other by the drive members 76. The drive members 76 are raised and extend out axially from the planar portions 78. The planar portions 78 may have generally frusto-conical shape or, in other embodiments, may be generally pie-shaped. As shown best in FIGS. 5 and 7-8, the drive portion 68 may also comprise a rounded portion 80. Preferably, the rounded portion 80 is generally ring-shaped and separates the outer surface 64 of the clutch disk 62 from the drive members 76 and planar portions 78.

The drive members 76 are formed on the drive portion 68 about the splined portion 70 and extend radially out therefrom. As above-described, the drive members 76 are spaced apart on the drive portion 68. Preferably, the drive members 76 are evenly spaced apart and separated from each other by planar portions 78 and the splined portion 70.

In an embodiment, each drive member 76 is provided at an angle of approximately 90° with respect to the adjacent drive member 76. In this embodiment, the drive members 76 are arranged so as to form a cross pattern. Further, each drive member 76 is preferably positioned at an angle of approximately 45° with respect to the planar portions 78 attached thereto. However, it should be appreciated that the orientation of the drive members 76 with respect to each other and/or the planar portions 78 may vary from the aforementioned embodiments.

Referring now to FIGS. 4-5, each drive member 76 preferably comprises a beveled edge portion 82. The beveled edge portions 82 may have a generally rectangular shape and comprise a beveled edge 84. Each beveled edge portion 82 may comprise a base 86. The beveled edge 84 is attached to the base 86. Preferably, each drive member 76 comprises a pair of beveled edge portions 82 attached to and separated from each other by a center portion 88. Thus, each drive member 76 preferably comprises a pair of beveled edges 84. The center portion 88 comprises a facing surface 90 and a front surface 92. In certain embodiments, the facing surface 90 may be generally planar and the front surface 92 may have a generally concave shape.

As above-noted, each planar portion 78 is attached to a pair of drive members 76. Preferably, the planar portion 78 is attached to the base 86 of the drive member 76. Further, where each drive member 76 is attached to a pair of planar portions 78 and comprises a pair of opposed beveled edge portions 82, each base 86 is attached to a separate planar portion 78.

Preferably, each beveled edge 84 is formed to be at an angle of ≧1° and ≦89° relative to the base 86 it is attached too. More preferably, each beveled edge 84 is formed to be at an angle of about 30° to about 60° relative to the attached base 86. In embodiments, where the drive members 76 comprise a pair of opposed beveled edges 84, the beveled edges 84 may be formed at substantially the same angle.

A radially extending groove 94 is provided in each drive member 76. Each radially extending groove 94 extends from the drive member 76 to the outer surface 64 of the clutch disk 62. In an embodiment, each radially extending groove 94 extends through the rounded portion 80. As shown best in FIGS. 7-8, each radially extending groove 94 comprises an inner portion 96 and an outer portion 98. Preferably, as shown best in FIG. 4, the inner portion 96 comprises a C-shaped portion 100 formed in the drive members 76.

The clutch 10 comprises an axially biasing member 102. As shown in FIGS. 5 and 7-8, the axially biasing member 102 is disposed between the driver member 26 and the clutch disk 62. The axially biasing member 102 biases the clutch disk 62 toward a driven member 144 through contact therewith. In these and in other embodiments, the axially biasing member 102 may also contact the inboard surface 28 of the driver member 26 and be radially positioned between the raised splined portion 42 and the inner wall 54 of the driver member 26.

The axially biasing member 102 is resilient. Preferably, the axially biasing member 102 is a spring. In an embodiment, the axially biasing member 102 is a compression spring such as, for example, a coil spring. However, it should be appreciated that the axially biasing member 102 may, in other embodiments, be a non-spring member or provided as another type of spring.

The clutch 10 comprises a plurality of balls 104. Each ball 104 is disposed in one of the radially extending grooves 94 in the drive portion 68. In an embodiment, four balls 104 are provided. Each ball 104 is preferably formed of steel. However, it should be appreciated that the plurality of balls 104 may be formed from another suitable material.

Preferably, the clutch 10 comprises a retaining member 106. In an embodiment, the retaining member 106 is formed in a unitary manner. Preferably, the retaining member 106 is formed as a rigid body with an aperture 108 extending there through. The retaining member 106 may be formed of glass filled nylon. However, other plastic materials may be suitable for use in forming the retaining member 106.

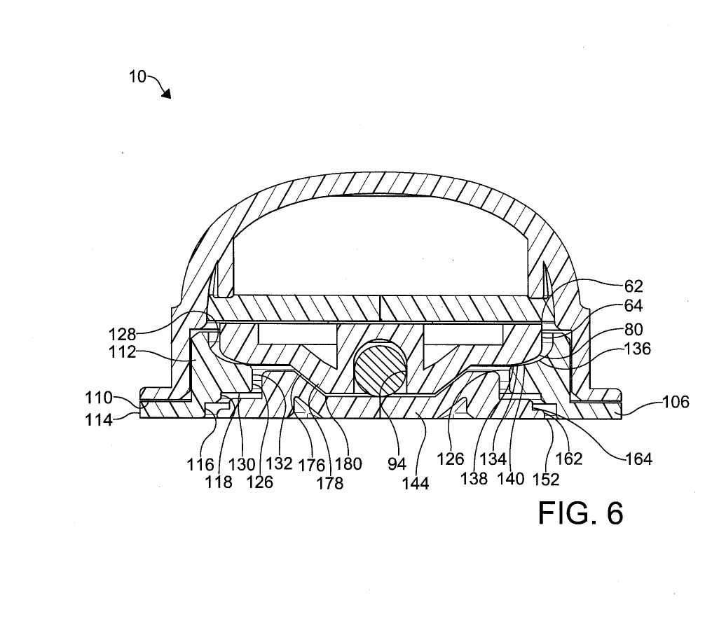

As shown in FIG. 4, the retaining member 106 is concentric with the driver member 26. Referring now to FIG. 6, the retaining member 106 is attached to an end 110 of the driver member 26. Preferably, the retaining member 106 is also attached to the upper portion 50 of the bowl-shaped portion 40. The retaining member 106 comprises a collar portion 112, an outer diameter portion 114 and an inner diameter portion 116. An intermediate diameter portion 118 may be provided between the collar portion 112 and the inner diameter portion 116. As shown best in FIG. 5, the collar portion 112 and the intermediate diameter portion 118 may have plurality of grooves 120 formed therein. Each of the grooves 120 extends from an end 122 of the collar portion 112, through the intermediate diameter portion 118 and terminates at an edge 124 of the inner diameter portion 116.

Referring back to FIG. 6, the collar portion 112 comprises a lip portion 126 attached to an inboard surface 128 and an outboard surface 130 attached to the lip portion 126. The outboard surface 130 may be provided in a perpendicular relationship with at least one of the inner diameter portion 116 and the intermediate diameter portion 118. The lip portion 126 provides an innermost diameter 132 for the retaining member 106. Preferably, the lip portion 126 has a diameter which is of a length that is substantially constant. The inboard surface 128 comprises a chamfered segment 134 and a concave segment 136. The chamfered segment 134 is attached to the lip portion 126 on one end 138 and the concave segment 136 on another end 140.

The chamfered segment 134 is formed to provide an angled surface. Preferably, the chamfered segment 134 is formed to be at an angle of ≧1° and ≦89° relative to the lip portion 126. More preferably, the chamfered segment 134 is formed at an angle of about 10° to about 30° relative to the lip portion 126.

As shown in FIG. 7, under normal operating conditions, the rounded portion 80 of the drive portion 68 is seated within the concave segment 136. Thus, the shape of the concave segment 136 is selected to provide a surface which receives at least a portion of the rounded portion 80. However, as shown in FIG. 8, under other operating conditions such as, for example, when the brush roller 18 is jammed, the plurality of balls 104 are seated within the concave segment 136. Therefore, the shape of the concave segment 136 is also selected to provide a surface which receives the plurality of balls 104 when they are positioned in the outer portion 98 of the radially extending grooves 94. Under the aforementioned operating conditions, a space 142 may be provided between the rounded portion 80 and the inboard surface 128 of the collar portion 112.

Referring now to FIGS. 4-8, the clutch 10 also comprises the driven member 144. The driven member 144 is separated from the axially biasing member by the clutch disk 62 and is concentric with the driver member 26. In an embodiment, the driven member 144 is formed in a unitary manner. Preferably, the driven member 144 is formed as a rigid body. In certain embodiments, the driven member 144 may be formed of glass filled nylon. However, other plastic materials may be suitable for use in forming the driven member 144. Preferably, the driven member 144 comprises an inboard surface 146, an outboard surface 148, an inner surface 150 and outer surface 152 which are concentric with each other.

As shown best in FIG. 5, the outboard surface 148 comprises a first portion 154 and a second portion 156 which are attached to each other. The first portion 154 may have a generally cylindrical shape and the second portion 156 may have a generally circular shape. Preferably, the first portion 154 is configured to engage the second drive belt 24. In this embodiment, the driven member 144 drives the brush roller 18 and the first portion 154 comprises a surface having a plurality of grooves 158. In other embodiments (not depicted), the first portion 154 may comprise a smooth surface.

As shown best in FIG. 4, the inner surface 150 of the driven member 144 defines an aperture 160. The aperture 160 extends axially from the outboard surface 148 through to the inboard surface 146. Preferably, the aperture 160 has a substantially constant diameter.

Referring now to FIG. 6, the outer surface 152 of the driven member 144 is defined by a first diameter portion 162 and a second diameter portion 164. In an embodiment, the length of the first diameter portion 162 is greater than that of the second diameter portion 164. The outer surface 152 of the driven member 144 abuts the collar portion 112 and is disposed within its inner diameter portion 116. Thus, the inner diameter portion 116 of the retaining member 106 is of a length which is greater than that of the first diameter portion 162.

Referring now to FIG. 4, the inboard surface 146 comprises a driven disk 166. The driven disk 166 comprises a plurality of recessed portions 168. Each recessed portion 168 is attached to a planar portion 170 on a side thereof. The driven disk 166 preferably comprises a center planar portion 172 circumferentially disposed around the driven member aperture 160 and attached to the planar portions 170. In an embodiment, the planar portions 170 and center planar portion 172 form a unitary cross-pattern. The driven disk 166 may further comprise a wall portion 174. In an embodiment, the wall portion 174 circumferentially surrounds the plurality of recessed portions 168 and planar portions 170.

Four recessed portion 168 may be provided in the driven disk 166. However, the clutch is not limited to embodiments with four recessed portions. Thus, less than four recessed portions may be provided or more than four recessed portions may be provided in the driven disk 166.

Each recessed portion 168 comprises a beveled edge portion 176. The beveled edge portions 176 may have a generally rectangular shape. Preferably, each beveled edge portion 176 comprises a beveled edge 178. More preferably, each beveled edge portion 176 also comprises a base 180 attached to the beveled edge 178. Most preferably, each recessed portion 168 comprises a pair of opposed beveled edge portions 176. Each beveled edge portion 176 may be attached to a planar portion 170.

Preferably, each beveled edge 178 is formed to be at an angle of ≧1° and ≦89° relative to the base 180 attached thereto. More preferably, each beveled edge 178 is formed to be at an angle of about 30° to about 60° relative to the base 180 attached thereto. In embodiments where each recessed portion 168 comprises a pair of opposed beveled edges 178, the beveled edges 178 may be formed at substantially the same angle.

Preferably, the recessed portions 168 further comprise a receiving portion 182 adjacent each beveled edge portion 176. In these embodiments, the pair of opposed beveled edge portions 176 are separated from each other by the receiving portion 182. Each receiving portion 182 comprises a face surface 184 and a frontal surface 186. Preferably, the face surface 184 is generally planar and the frontal surface 186 has a generally convex shape.

To transmit torque to the brush roller 18, the clutch disk 62 engages the driven member 144. The clutch disk 62 is engaged with the driven member 144 via direct contact between the beveled edges 84, 178 of the drive members 76 and the recessed portions 168. As illustrated in FIG. 7, the driven member 144 is disposed adjacent the plurality of balls 104 when it is engaged with the clutch disk 62.

In certain embodiments, the driven disk 166 is engaged with the drive portion 68 of the clutch disk 62. When engaged with the driven disk 166, the drive members 76 of the drive portion 68 are positioned within the recessed portions 168 of the driven disk 166. Preferably, in these embodiments, each drive member 76 is received by a receiving portion 182 of the recessed portions 168.

The clutch 10 comprises a shaft 188. Preferably, the shaft 188 is formed from steel. However, other sufficiently rigid materials may be utilized to form the shaft 188. The shaft 188 has a long axis 190 and a pair of end portions 192, 194. In an embodiment, a first bearing set 196 and a second bearing set 198 are coupled to one of the end portions 192, 194 to facilitate rotation of the clutch 10. Preferably, the first and second bearing sets 196, 198 are press fit onto the shaft 188.

The shaft 188 supports the other rotatable elements of the clutch 10. The shaft 188 extends through the aperture 61 in the driver member 26. Preferably, the driver member 26 is molded onto the shaft 188. However, the shaft 188 and the driver member 26 may be separable bodies. The shaft 188 also extends through the aperture 74 in the clutch disk 62 and past the axial biasing member 102 which is provided about a portion of the shaft. In embodiments where the axially biasing member 102 is a coil spring, the axially biasing member 102 may comprise a helical portion 200 provided about a portion of the shaft 188.

The shaft 188 extends through the aperture 160 defined by the inner surface 150 of the driven member 144. The plurality of balls 104 are positioned about a portion of the shaft 188. In an embodiment, a pair of bearing sets 202, 204 are disposed within the aperture 160 to rotatably support the shaft 188. The shaft 188 may also comprise a recessed portion 206 for ensuring a secure fit between one of the bearing sets 202 and the shaft 188. Preferably, the bearing sets 202, 204 are separated by a cylindrically shaped spacer 208. The shaft 188 extends through the pair of bearing sets 202, 204, driven member 144 and, when provided, the spacer 208. A washer 210 may be disposed on the shaft 188 between the driven member 144 and the first bearing set 196.

The torque transmitting capacity of the clutch 10 is a function of the biasing force of the axially biasing member 102, the angles at which the beveled edges 84, 178 are formed, and the coefficient of friction between the drive portion 68 and the driven disk 166. In operation, the driver member 26 receives torque from the motor via the first drive belt 20. The first drive belt 20 rotates the driver member 26. Torque is transferred to the clutch disk 62 via the splined connection between the driver member 26 and the disk 62. Frictional contact from and rotation of the clutch disk 62 causes the driven disk 166 to rotate. The driven disk 166 is attached to the second drive belt 24 which rotates to drive the brush roller 18.

However, if an object is ingested by the vacuum sweeper 12 such that the brush roller 18 becomes jammed, the motor will increase the amount of torque it supplies to the driver member 26 in an attempt to get the brush roller 18 rotating again. If the jam is not relieved and the brush roller 18 does not rotate, the torque supplied by the motor will continue to rise until the torque capacity of the clutch 10 is exceeded.

When this occurs, the clutch disk 62 will slip and an axial force will be applied to the clutch disk 62 and transmitted to the axially biasing member 102. The axial force will move the clutch disk 62 away from the driven member 144 and the retaining member 106 and compress the axially biasing member 102. As the clutch disk 62 moves away from the driven member 144 and the retaining member 106, centrifugal forces acting upon the balls 104 moves each ball 104 radially outward from the inner portion 96 toward the outer portion 98 of the groove 94 each ball is disposed in.

As the torque transmitted from the motor continues to increase, the distance between the retaining member 106 and the clutch disk 62 will continue to increase until the distance between the retaining member 106 and the clutch disk 62 is such that each ball 104 can move radially outward from the inner portion 96 into the outer portion 98 of each groove 94. Once the balls 104 have moved adjacent an outer edge 212 of the groove 94, the clutch disk 62 will have moved a sufficient distance axially such that the drive members 76 will no longer contact the recessed portions 168 of the driven disk 166. Thus, the clutch disk 62 will no longer be engaged with the driven member 144 to transmit torque there through.

It should be noted that while the driven disk 166 is stationary under these conditions, the shaft 188 will continue to rotate within the bearing sets 202, 204. Also, the clutch disk 62 will continue to rotate. Thus, centrifugal forces will continue to act upon each ball 104 and, while the motor is energized, the rotation of the clutch disk 62 will provide sufficient centrifugal force to maintain the position of each ball 104 in the outer portion 98 of each groove 94.

As shown in FIG. 8, when positioned in the outer portion 98 of each groove 94, each ball 104 is positioned between the collar portion 112 of the retaining member 106 and the clutch disk 62. Further, while in the outer portion 98 of each groove 94, each ball 104 directly contacts the inboard surface 128 of the collar portion 112 and the drive portion 68 of the clutch disk 62. In this position, the balls 104 prevent the clutch disk 62 from re-engaging the driven member 144. Thus, in certain embodiments, the clutch 10 will comprise each ball 104 positioned in the outer portion 98 of the groove 94. Preferably, each ball 104 is positioned in the outer portion 98 of the groove 94 such that each ball 104 contacts the chamfered segment 134 and the concave segment 136 of the collar portion 112. Also, each ball 104 is positioned such that a portion of the ball 104 extends beyond the outer edge 212 of the radially extending groove 94 the ball 104 is disposed in. Under these conditions, the driven disk 166 is separated from the drive portion 68 of the clutch disk 62 by a space 214.

When the vacuum sweeper 12 is turned off to clear the jam, the motor, first drive belt 20, driver member 26, clutch disk 62 and shaft 188 coast to a stop. As the rate at which the clutch disk 62 rotates decreases, the centrifugal force acting on the balls 104 is reduced allowing the balls 104 to move radially inward to the inner portion 96 of each groove 94. At this point, the clutch disk 62 re-engages the driven member 144. Thus, once the jam is removed from the brush roller 18, normal operation may resume.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What we claim is:

1. A clutch for a vacuum sweeper, comprising:
a driver member;
a clutch disk engaged with the driver member, the clutch disk comprising a drive portion;
an axially biasing member disposed between the driver member and the clutch disk;
a shaft extending past the axial biasing member and through the driver member and the clutch disk;
a plurality of balls positioned about the shaft, each ball disposed in a radially extending groove in the drive portion; and
a driven member comprising a driven disk, the driven disk positioned adjacent the plurality of balls and engaged with the drive portion.

2. The clutch defined by claim 1, further comprising a retaining member attached to an end of the driver member, the retaining member having an inner diameter which is larger than the outer diameter of the driven member.

3. The clutch defined by claim 1, wherein the drive portion comprises a plurality of drive members, each drive member having one of the radially extending grooves formed therein and engaged with a recessed portion formed in the driven disk.

4. The clutch defined by claim 1, wherein the driver member is molded to the shaft.

5. The clutch defined by claim 1, wherein the driver member is driven by a toothed belt.

6. The clutch defined by claim 1, wherein the axially biasing member is a coil spring provided about the shaft.

7. The clutch defined by claim 1, wherein the driver member and the driven member each comprises a generally cylindrical grooved outer surface.

8. The clutch defined by claim 1, wherein the clutch disk and driver member are engaged by a splined connection.

9. The clutch defined by claim 1, further comprising a pair of bearing sets which rotatably support the shaft.

10. The clutch defined by claim 1, wherein the axial biasing member biases the clutch disk toward the driven member.

11. The clutch defined by claim 1, wherein the axial biasing member contacts an inner surface of the driver member and is positioned between a raised splined portion and an inner wall thereof.

12. The clutch defined by claim 1, wherein driver member, clutch disk, axial biasing member, shaft and driven member are concentric.

13. The clutch defined by claim 3, wherein the drive members are spaced apart and each is provided at an angle of approximately 90° with respect to an adjacent drive member.

14. The clutch defined by claim 3, wherein each recessed portion and each drive member comprises a beveled edge and wherein the beveled edge of the drive member contacts the beveled edge of the recessed portion.

15. A clutch for a vacuum sweeper, comprising:
a driver member, the driver member comprising an inner surface and a generally cylindrical outer surface having a plurality of grooves formed therein;
a retaining member attached to an end of the driver member, the retaining member comprising an inner surface having a lip disposed thereon;
a clutch disk disposed between the lip of the retaining member and the inner surface of the driver member and engaged to the driver member, the clutch disk comprising a drive surface;
an axially biasing member disposed between the driver member and the clutch disk;
a shaft extending past the axial biasing member and through the driver member and the clutch disk;
a plurality of balls positioned about the shaft, wherein each ball is disposed in a radially extending groove in the drive portion; and
a driven member comprising a driven disk, the driven disk is positioned adjacent the plurality of balls and engages the drive portion.

16. The clutch defined by claim 15, wherein driver member, retaining member, clutch disk, axial biasing member, shaft and driven member are concentric.

17. A clutch for a vacuum sweeper, comprising:
a driver member;
a clutch disk engaged with the driver member, the clutch disk comprising a drive portion having a plurality of raised drive members and radially extending grooves, a ball is disposed in each groove and positioned in an outer portion of the groove;
an axially biasing member disposed between the driver member and the clutch disk; and
a driven member separated from the axial biasing member by the clutch disk, the driven member comprising a driven disk separated from the drive portion by a space.

18. The clutch defined by claim 17, further comprising a shaft extending through the driven member, axial biasing member, driver member and the clutch disk.

19. The clutch defined by claim 17, further comprising a retaining member attached to an end of the driver member, wherein the retaining member comprises a collar portion in contact with each ball.

20. The clutch defined by claim 17, wherein a portion of each ball extends beyond the outer edge of the groove the ball is disposed in.
